(19) United States
(12) Patent Application Publication
(10) Pub. No.: US 2023/0137229 A1
(43) Pub. Date: May 4, 2023

(54) Clamping Tool with Cross-Over Components

(71) Applicant: Milwaukee Electric Tool Corporation, Brookfield, WI (US)

(72) Inventors: Matthew Zimmerman, Franksville, WI (US); Charlie G. Noble, New Berlin, WI (US); Colin J. Roberts, Brookfield, WI (US)

(21) Appl. No.: 18/147,529

(22) Filed: Dec. 28, 2022

Related U.S. Application Data
(63) Continuation of application No. PCT/US2022/078787, filed on Oct. 27, 2022.
(60) Provisional application No. 63/273,029, filed on Oct. 28, 2021.

(51) Int. Cl. B25B 7/08

(52) U.S. Cl. CPC B25B 7/08

(57) ABSTRACT

A clamping tool, such as pliers, is provided. The clamping tool includes a pair of handles that each have a grip section connected to a neck section. A pivot joint connects the neck sections to each other, such that when the grip sections move with respect to one another, the neck sections pivot about the pivot joint. The neck sections are configured to cross one another at a location spaced apart from the pivot joint when the grip sections are drawn sufficiently close to one another.

### CROSS-REFERENCE TO RELATED APPLICATIONS

This application is a continuation of International Application No. PCT/US2022/078787, filed Oct. 27, 2022, which claims the benefit of and priority to U.S. Provisional Application No. 63/273,029, filed Oct. 28, 2021, each of which are incorporated herein by reference in their entireties.

### BACKGROUND OF THE INVENTION

The present invention relates generally to the field of tools. The present invention relates specifically to clamping tools having components pivotally coupled together, and the components cross over one another at a location spaced apart from the location at which the components pivot with respect to one another.

### SUMMARY OF THE INVENTION

One embodiment of the invention relates to a clamping tool including a lower jaw, a first component, an upper jaw, a second component, and a pivot joint. The first component includes a first neck section extending from a first neck end to an opposing second neck end, the lower jaw at the first neck end, a first cross over section extending upwardly from a first cross over end to an opposing second cross over end, the first neck section at the first cross over end, and a first grip section extending from a first grip end to an opposing second grip end, the first cross over section at the first grip end. The upper jaw is on an opposite side of a longitudinal axis of the clamping tool from the lower jaw. The second component includes a second neck section extending from a first neck end to an opposing second neck end, the upper jaw at the first neck end of the second component, a second cross over section extending downwardly from a first cross over end to an opposing second cross over end, the second neck section at the first cross over end of the second component, and a second grip section extending from a first grip end to an opposing second grip end, the second cross over section at the first grip end of the second component. The pivot joint pivotably couples the first component to the second component at the location at which the first neck section extends from the lower jaw and the second neck section extends from the upper jaw. The first component and the second component pivot with respect to each other about a rotational axis as the upper jaw and the lower jaw are moved between an open configuration in which the upper jaw and the lower jaw are spaced apart and a closed configuration in which the upper jaw and the lower jaw contact each other. The clamping tool defines a first distance along the longitudinal axis between the rotational axis and the second neck end of the first neck section when the upper jaw and the lower jaw are in the closed configuration, and a second distance along the longitudinal axis between the second cross over end of the first grip section and a center point at which the first cross over section crosses over the second cross over section when the upper jaw and the lower jaw are in the closed configuration. The second distance is less than 50% of the first distance.

Another embodiment of the invention relates to a lower jaw, a first component, an upper jaw, a second component, and a pivot joint. The first component includes a first neck section extending from a first neck end to an opposing second neck end, the lower jaw at the first neck end, a first cross over section extending upwardly from a first cross over end to an opposing second cross over end, the first neck section at the first cross over end, and a first grip section extending from a first grip end to an opposing second grip end, the first cross over section at the first grip end. The upper jaw is on an opposite side of a longitudinal axis of the clamping tool from the lower jaw. The second component includes a second neck section extending from a first neck end to an opposing second neck end, the upper jaw at the first neck end of the second component, a second cross over section extending downwardly from a first cross over end to an opposing second cross over end, the second neck section at the first cross over end of the second component, and a second grip section extending from a first grip end to an opposing second grip end, the second cross over section at the first grip end of the second component. The pivot joint pivotably couples the first component to the second component at the location at which the first neck section extends from the lower jaw and the second neck section extends from the upper jaw. The first component and the second component pivot with respect to each other about a rotational axis as the upper jaw and the lower jaw are moved between an open configuration in which the upper jaw and the lower jaw are spaced apart and a closed configuration in which the upper jaw and the lower jaw contact each other, such that moving the grip section of the first component away from the grip section of the second component draws the upper jaw and the lower jaw apart from one another into an open configuration and moving the grip section of the first component towards the grip section of the second component draws the upper jaw and the lower jaw together into a closed configuration. When the upper jaw and the lower jaw are in a closed configuration, the first cross over section of the first component crosses over the second cross over section of the second component, and the first cross over end of the first component is located below the first cross over end of the second component. As the upper jaw and the lower jaw are moved from the closed configuration to the open configuration, the first cross over section of the first component uncrosses from the second cross over section of the second component such that the first cross over end of the first component is positioned above the first cross over end of the second component.

Another embodiment of the invention relates to a clamping tool including a lower jaw, a first component, an upper jaw, a second component, and a pivot joint. The first component includes a first neck section extending from a first neck end to an opposing second neck end, the lower jaw at the first neck end, a first cross over section extending upwardly from a first cross over end to an opposing second cross over end, the first neck section at the first cross over end, and a first grip section extending from a first grip end to an opposing second grip end, the first cross over section at the first grip end. The upper jaw is on an opposite side of a longitudinal axis of the clamping tool from the lower jaw. The second component includes a second neck section extending from a first neck end to an opposing second neck end, the upper jaw at the first neck end of the second component, a second cross over section extending downwardly from a first cross over end to an opposing second cross over end, the second neck section at the first cross over end of the second component, and a second grip section extending from a first grip end to an opposing second grip end, the second cross over section at the first grip end of the second component. The pivot joint pivotably couples the first component to the second component at the location at which the first neck section extends from the lower jaw and the second neck section extends from the upper jaw. The first component and the second component pivot with respect to each other about a rotational axis as the upper jaw and the lower jaw are moved between an open configuration in which the upper jaw and the lower jaw are spaced apart and a closed configuration in which the upper jaw and the lower jaw contact each other, such that moving the grip section of the first component away from the grip section of the second component draws the upper jaw and the lower jaw apart from one another into an open configuration and moving the grip section of the first component towards the grip section of the second component draws the upper jaw and the lower jaw together into a closed configuration. When the upper jaw and the lower jaw are in the closed configuration, the first neck section extends downwardly from the lower jaw at an angle of less than 45 degrees relative to the longitudinal axis and the second neck section extends upwardly from the upper jaw at an angle of less than 45 degrees with respect to the longitudinal axis. As the upper jaw and the lower jaw are moved into the open configuration, the first neck section is drawn upward until the first neck section extends upwardly from the lower jaw and the second neck section is drawn downward until the second neck section extends downwardly from the upper jaw.

Another embodiment of the invention relates to a clamping tool having a first component pivotably connected to a second component. The first component has a first neck section that is connected to an upper grip section, and the second component has second neck section that is connected to a lower grip section. A pivot joint connects the first neck section to the second neck section, such the first neck section and the second neck section respectively pivot about the pivot joint when the upper grip section and the lower grip section are moved with respect to one another. The first component and the second component are configured to cross over one another at a location spaced apart from the pivot joint when the upper grip section is moved sufficiently toward the lower grip section.

In specific embodiments, the first component and the second component are further configured to uncross from one another when the upper grip section is positioned a sufficient distance apart from the lower grip section.

Alternative exemplary embodiments relate to other features and combinations of features as may be generally recited.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a clamping tool having cross-over components, according to an exemplary embodiment.

FIG. 2 is a side view of the clamping tool of FIG. 1, according to an exemplary embodiment.

FIG. 3 is a side view of a clamping tool having cross-over components, according to another exemplary embodiment.

FIG. 4 is a side view of a clamping tool having cross-over components, according to another exemplary embodiment.

FIG. 5 is a top view of a clamping tool having cross-over components, according to another exemplary embodiment.

FIG. 6 is a side view of a clamping tool having cross-over components, according to another exemplary embodiment.

FIG. 7 is a side view of a clamping tool having cross-over components, according to another exemplary embodiment.

FIG. 8 is an exploded view of the clamping tool of FIG. 7, according to an exemplary embodiment.

FIG. 9 is a side view of the clamping tool of FIG. 7, shown in an open position, according to an exemplary embodiment.

FIG. 10 is a rotated side view of the clamping tool of FIG. 7, shown in a closed position, according to an exemplary embodiment.

FIG. 11 is a side view of the clamping tool of FIG. 10, shown with a pair of upper and lowers jaws opened 0.5 inches, according to an exemplary embodiment.

FIG. 12 is a side view of the clamping tool of FIG. 10, shown with the pair of upper and lowers jaws opened 1 inch, according to an exemplary embodiment.

FIG. 13 is a side view of the clamping tool of FIG. 10, shown with the pair of upper and lowers jaws opened 1.5 inches, according to an exemplary embodiment.

FIG. 14 is a side view of the clamping tool of FIG. 10, shown with the pair of upper and lowers jaws opened 2 inches, according to an exemplary embodiment.

### DETAILED DESCRIPTION

Referring generally to the figures, various embodiments of a tool having cross-over components are shown. In the particular embodiments discussed herein, the tool is a clamping tool. The clamping tool has a first component coupled to (e.g., specifically integral with) a lower jaw and a second component coupled to (e.g., specifically integral with) an upper jaw. The first component is pivotally connected to the second component, such as by a pivot joint, such that movement of the first component with respect to the second component generates coinciding movement of the lower jaw with respect to the upper jaw. The first component includes a first neck section that extends at a small angle downward from the pivot joint when the component is in a closed position. A first crossover section is coupled to (e.g., specifically integral with) the first neck section and extends at an angle upward from the first neck section to join to an upper grip. The second component includes a second neck section that extends at a small angle upward from the pivot joint. A second crossover section is coupled to (e.g., specifically integral with) the second neck section and extends at an angle downward from the second neck section to join to a lower grip.

In contrast to standard clamping tools, such as pliers where the handles cross during use only at one or more points of connection, such as at a pivot joint, the components here are configured to additionally cross at a location spaced apart from the pivot joint. When the first and second grips are moved with respect to one another, the first crossover section moves substantially freely over the second crossover section. Applicant has found this cross-over component configuration to permit a smaller angular separation of the neck sections while maintaining the same jaw-opening size as a standard pliers. The narrower neck profile generated by this configuration reduces the amount of clearance required to open and close the clamping tool, allowing the clamping tool to operate within tighter spaces, for example, to connect automotive hoses in hard-to-reach locations. Further, an exemplary embodiment of a clamping tool having a cross-over component configuration, as described herein, is more cost-efficient to manufacture and offers greater mechanical advantage to the user than other known solutions for narrowing a clamping tool's neck profile, such as double pivot mechanisms.

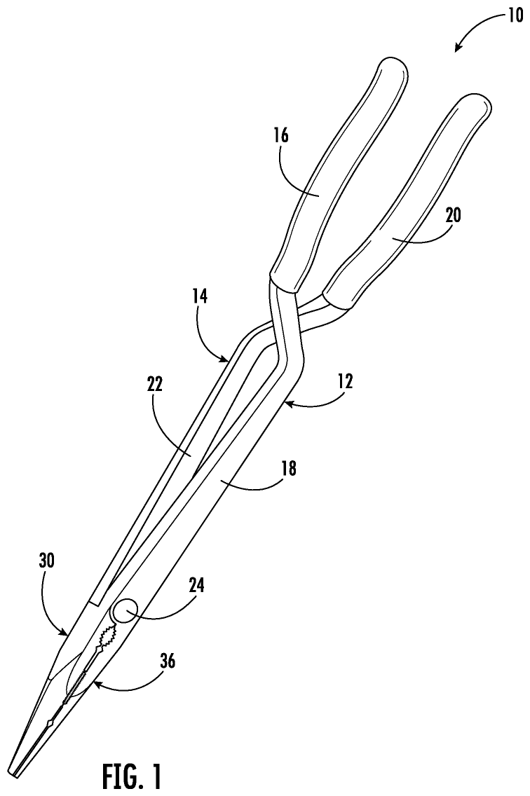

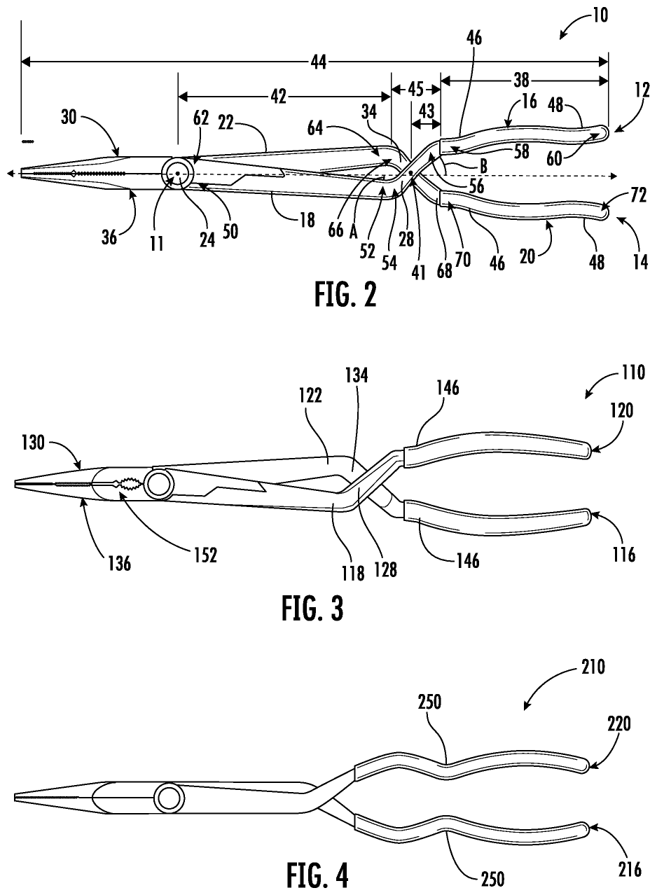

FIGS. 1-2 show various views of a clamping tool 10, such as pliers. Clamping tool 10 includes a first component 12 and a second component 14. The first component 12 is coupled to a lower jaw 36 and the second component 14 is coupled to an upper jaw 30. In the embodiment shown here, the first component 12 is integrally formed with the lower jaw 36, and the second component 14 is integrally formed with the upper jaw 30. In other embodiments, other generally rigid forms of mechanical coupling are permissible. Further, the jaws shown in FIG. 2 are symmetric with respect to the longitudinal axis 25 of the clamping tool 10 (e.g., the horizontal axis) and form a generally straight profile along the longitudinal axis 25 of the clamping tool 10. The first component 12 is connected to the second component 14 by a pivot joint 24.

In various embodiments, the upper jaw 30 is on an opposite side of longitudinal axis 25 of the clamping tool 10 from the lower jaw 36, with upper jaw 30 being above longitudinal axis 25 and lower jaw 36 being below longitudinal axis 25. Stated another way, the term downward is in reference to the upper jaw 30 and the lower jaw 36, and means the lower jaw 36 is on the opposite side of the longitudinal axis 25 from the upper jaw 30, and the term upward is in reference to the upper jaw 30 and the lower jaw 36, and means the upper jaw 30 is the opposite side of the longitudinal axis 25 from the lower jaw 36.

Referring to FIG. 2, the first component 12 includes first neck section 18 extending from a first neck end 50 to an opposing second neck end 52, the lower jaw 36 at the first neck end 52, a first cross over section 28 extending upwardly from a first cross over end 54 to an opposing second cross over end 56, the first neck section 18 at the first cross over end 54, and a first grip section 16 extending from a first grip end 58 to an opposing second grip end 60, the first cross over section 28 at the first grip end 58. Stated another way, first neck section 18 is coupled to and extends from lower jaw 36, such as via being integrally formed, first cross over section 28 is coupled to and extends from first neck section 18, such as via being integrally formed, and first grip section 16 is coupled to and extends from first cross over section 28, such as via being integrally formed.

First neck section 18 extends downward from the pivot joint 24 at an angle A from the longitudinal axis 25 of the clamping tool 10 when clamping tool 10 is in the closed configuration. In various embodiments, angle A is less than 45 degrees with respect to longitudinal axis 25, and more specifically is less than 30 degrees, and even more specifically is less than 10 degrees.

The first cross over section 28 extends upward from the first neck section 18 at an angle B with respect to the longitudinal axis 25 of the clamping tool 10 when clamping tool 10 is in the closed configuration, joining the first neck section 18 to an first grip section 16. In various embodiments, angle B is less than 60 degrees with respect to the longitudinal axis 25, and more specifically is less than 50 degrees. In various embodiments, angle B is between 35 degrees 55 degrees, and more specifically is 45 degrees. In various embodiments, angle A is less than the angle B, and more specifically angle A is less than half of angle B.

In various embodiments, when clamping tool 10 is in the closed configuration the second neck end 52 of the first component 12 is below the second neck end 64 of the second component 14 and the first grip end 58 of the first component 12 is above the first grip end 70 of the second component 14.

In various embodiments, second component 14 is symmetrical to first component 12 with respect to longitudinal axis 25. Second component 14 includes second neck section 22 extending from a first neck end 62 to an opposing second neck end 64, the upper jaw 30 at the first neck end 62, a second cross over section 34 extending upwardly from a first cross over end 66 to an opposing second cross over end 68, the second neck section 22 at the first cross over end 66, and a second grip section 20 extending from a first grip end 70 to an opposing second grip end 72, the second cross over section 34 at the first grip end 70. Stated another way, second neck section 22 is coupled to and extends from upper jaw 30, such as via being integrally formed, second cross over section 34 is coupled to and extends from second neck section 22, such as via being integrally formed, and second grip section 20 is coupled to and extends from second cross over section 34, such as via being integrally formed.

Second neck section 22 extends upward from the pivot joint 24 at an angle symmetrical to angle A as first neck section 18 when clamping tool 10 is in the closed configuration. The second cross over section 34 extends upward from the second neck section 22 at an angle symmetrical to angle B with respect to the longitudinal axis 25 of the clamping tool 10, joining the second neck section 18 to a second grip section 20. For example, in various embodiments when the upper jaw 30 and the lower jaw 36 are in the closed configuration, the first neck section 18 extends downwardly from the lower jaw 36 at an angle of less than 45 degrees relative to the longitudinal axis 25 and the second neck section 22 extends upwardly from the upper jaw 30 at an angle of less than 45 degrees with respect to the longitudinal axis 25.

The first and second neck sections 18, 22 shown in FIGS. 1-2 are generally straight and elongate. Here, the first and second neck sections 18, 22 are integrally formed with the first and second crossover sections 28, 34, though in other embodiments, other generally rigid forms of mechanical coupling are permissible. In the embodiments shown, the first and second components 12, 14 do not form an additional mechanical connection to one another at the first and second crossover sections 28, 34.

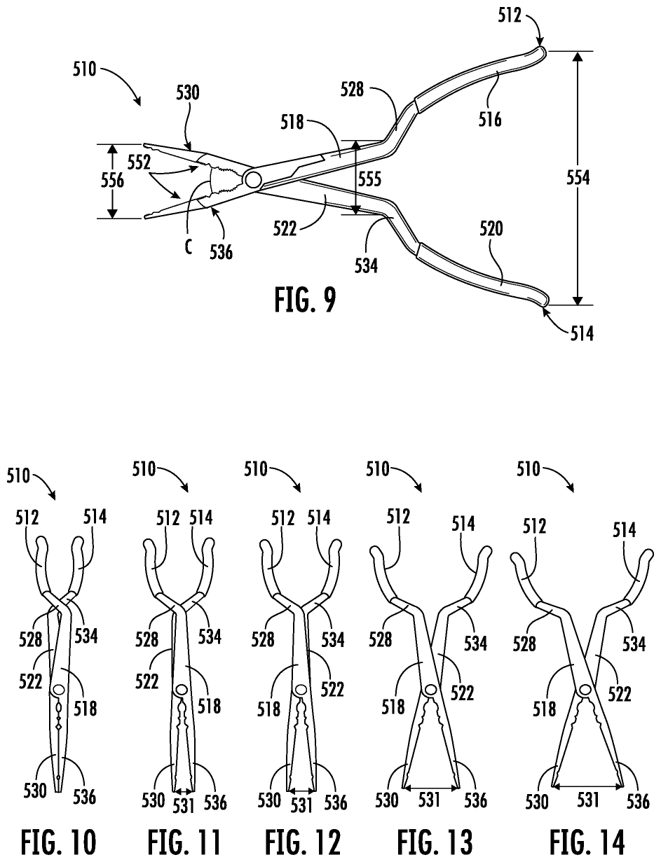

When the first grip section 16 and the second grip section 20 are moved sufficiently close to one another, the first cross over section 28 is crossed over the second crossover section 34 at cross over point 41. The first and second cross over sections 28, 34 are substantially free to move with respect to one another as directed by the movement of the first and second grip sections 16, 20. Further, in certain embodiments, the first and second crossover sections 28, 34 may substantially uncross from one another as the first and second grip section 16, 20 are drawn sufficiently away from one another (FIG. 9).

In this embodiment, the clamping tool 10 is formed, at least in part, of forged steel, which is resistant to corrosion damage and damage from drops. However, other rigid materials may be permissible, as well. The first and second grip sections 16, 20 shown in FIG. 2 are formed by covering a portion of the rigid material forming the clamping tool with a more compliant material suitable for supporting the grip of a human hand, such as by dipping the rigid portion in a PVC grip material. Other means of forming grip section that are known in the art are also permissible. The grip sections shown in FIG. 2 each include a first dip 46 near the location where the respective grip section 16, 20 connects to the respective crossover section 28, 34, as well as a second dip 48 near the opposite end of the grip section 16, 20.

Pivot joint 24 pivotably couples first component 12 to the second component 14 at the location at which the first neck section 18 extends from the lower jaw 36 and the second neck section 22 extends from the upper jaw 30. First component 12 and second component 14 pivot with respect to each other about a rotational axis 11 as the upper jaw 30 and the lower jaw 36 are moved between an open configuration in which the upper jaw 30 and the lower jaw 36 are spaced apart and a closed configuration in which the upper jaw 30 and the lower jaw 36 contact each other.

Moving the first grip section 16 of the first component 12 away from the second grip section 20 of the second component 14 draws the upper jaw 30 and the lower jaw 36 apart from one another into an open configuration. Moving the first grip section 16 of the first component 12 towards the second grip section 20 of the second component 14 draws the upper jaw 30 and the lower jaw 36 together into a closed configuration. As the upper jaw 30 and the lower jaw 36 are moved into the open configuration from the closed configuration, the first neck section 18 is drawn upward until the first neck section 18 extends upwardly from the lower jaw 36 and the second neck section 22 is drawn downward until the second neck section 22 extends downwardly from the upper jaw 30. As the upper jaw 30 and the lower jaw 36 are moved from the closed configuration to the open configuration, the first cross over section 28 of the first component 12 uncrosses from the second cross over section 34 of the second component 14 such that the first cross over end 54 of the first component 12 is positioned above the first cross over end 66 of the second component 14. When the upper jaw 30 and the lower jaw 36 are in a closed configuration, the first cross over section 28 of the first component 12 crosses over the second cross over section 34 of the second component 14 and the first cross over end 54 of the first component 12 is located below the first cross over end 66 of the second component 14.

When the upper jaw 30 and the lower jaw 36 are in a closed configuration, the second cross over end 56 of the first component 12 is above the second neck end 64 of the second component 14. When the upper jaw 30 and the lower jaw 36 are in a closed configuration, the second grip end 60 of the first component 12 is above the first grip end 58 of the first component 12. When the upper jaw 30 and the lower jaw 36 are in a closed configuration, the first grip end 58 of the first component 12 is above the first grip end 70 of the second component 14.

In various embodiments, clamping tool 10 includes and/or defines a first distance 42 along the longitudinal axis 25 between the rotational axis 11 and the second neck end 52 of the first neck section 18 when the upper jaw 30 and the lower jaw 36 are in the closed configuration. Clamping tool 10 also includes and/or defines a second distance 43 along the longitudinal axis 25 between the second cross over end 56 of the first grip section 28 and a center point 41 at which the first cross over section 28 crosses over the second cross over section 34 when the upper jaw 30 and the lower jaw 36 are in the closed configuration. In various embodiments, the second distance 43 is less than 50% of the first distance 42, and more specifically second distance 43 is less than 25% of the first distance 42, or more specifically second distance 43 is equal to 20% of the first distance 42.

Clamping tool 10 also includes and/or defines a third distance 44 that is the entire length of the clamping tool 10 along the longitudinal axis 25 when the upper jaw 30 and the lower jaw 36 are in the closed configuration, and the first distance 42 is at least 25% of the third distance 44.

Clamping tool 10 also includes and/or defines a fourth distance 38 between the first grip end 58 of the first grip section 16 and the second grip end 60 of the first grip section 16 along the longitudinal axis 25 when the upper jaw 30 and the lower jaw 36 are in the closed configuration. Clamping tool 10 also includes and/or defines a fifth distance 45 between the first cross over end 54 of the first grip section 28 and the second cross over end 56 of the first grip section 28 along the longitudinal axis 25 when the upper jaw 30 and the lower jaw 36 are in the closed configuration.

In various embodiments, the first distance 42 is at least 50% of the sum of the fourth distance 38 plus the fifth distance 45 (i.e., first distance 42>=(0.5*(fourth distance 38+fifth distance 45))). In various embodiments, second distance 43 is less than 25% of the fourth distance 38.

In various embodiments, the distance 38 (e.g., the horizontal grip section length) is between approximately 4.5 to 8.5 inches, and more specifically approximately 4.2 inches (107 mm). In various embodiments, the distance 44 (e.g., the overall horizontal length when closed) is between 11 to 16.5 inches, and more specifically is approximately 13 inches (330 mm). The elongated profile of the neck permits the clamping tool 10 to be inserted into narrow spaces. Further, the relatively straight, elongated profile of the neck sections 18, 22 permits the neck sections 18, 22 to be operated in narrower spaces. Adding length to the first and second neck sections 18, 22 increases the distance the first and second grip sections 16, 20 must be drawn apart prior to the first and second crossover sections 28, 34 uncrossing and beginning to increase the width of the neck profile.

Referring to FIG. 3, clamping tool 110 is shown according to an exemplary embodiment. Clamping tool 110 is substantially the same as clamping tool 10 except for the differences discussed herein. Here the neck sections 118, 122 and crossover sections 128, 134 are the substantially the same as shown in FIG. 2. However, the upper and lower grip sections 116, 120 are formed with a different shape. Here, the upper and lower grips 116, 120 are formed with a dip 146 only where the respective grip section 116, 120 connects to the respective crossover section 128, 134. Additionally, the upper and lower jaws 130, 136 include a plurality of versatile gripping zones 152 to support a wider variety of gripping tasks that may require different griping shapes, different level or form of serrations, etc. for maximized gripping performance.

Referring to FIG. 4, clamping tool 210 is shown according to an exemplary embodiment. Clamping tool 210 is substantially the same as clamping tool 10 and clamping tool 110 except for the differences discussed herein. Clamping tool 210 include yet another shape of grip section that may be applied to the crossover handle configuration disclosed herein. Here, upper and lower grip sections 216, 220 are shown having a single dip 250 positioned at a generally intermediate location of each grip section 216, 220.

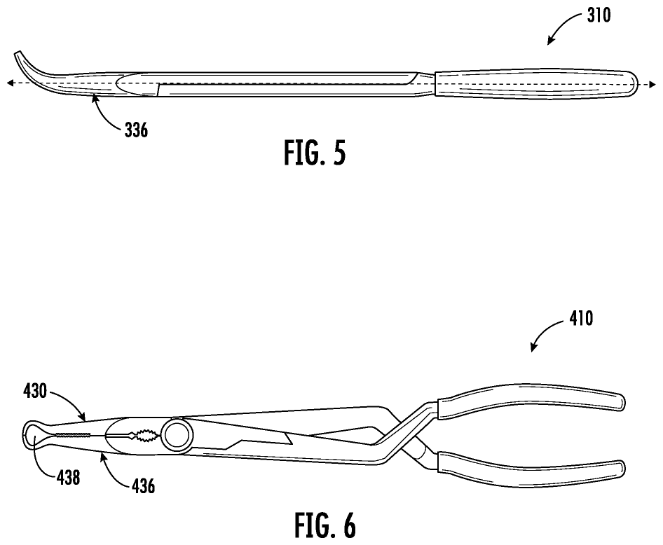

Referring to FIG. 5, clamping tool 310 is shown according to an exemplary embodiment. Clamping tool 310 is substantially the same as clamping tool 10 and clamping tool 110 except for the differences discussed herein. Clamping tool 310 include yet another jaw configuration that may be applied to the crossover handle configuration disclosed herein. Here, the lower jaw 336 includes a 45-degree angle of its tip with respect to the horizontal axis 325 of the clamping tool 310. Though the upper jaw is not shown here, it forms the same angle as lower jaw 336.

Referring to FIG. 6, clamping tool 410 is shown according to an exemplary embodiment. Clamping tool 410 is substantially the same as clamping tool 10 and clamping tool 110 except for the differences discussed herein. Clamping tool 410 is a hose grip pliers and includes yet another jaw configuration that may be applied to the crossover handle configuration disclosed herein. Here, the upper and lower jaws 430, 436 together form an opening 438 sized to grip a hose, such as an automotive hose.

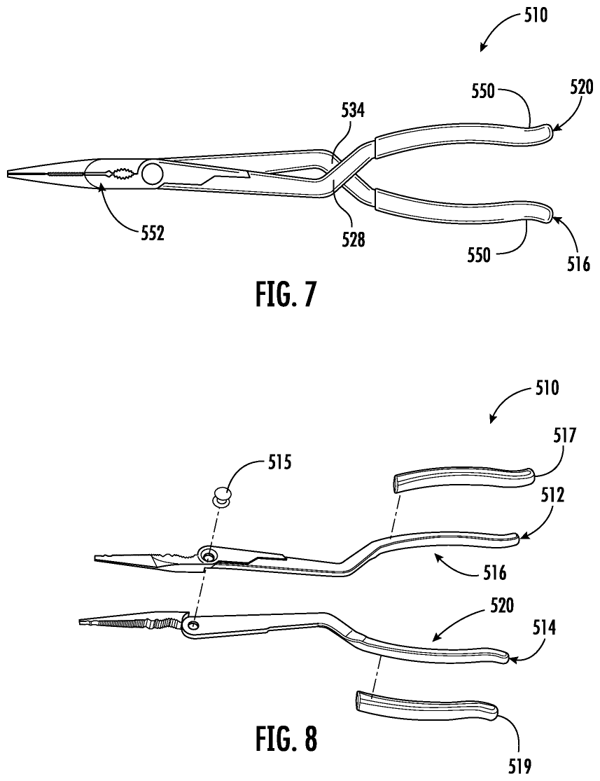

Referring to FIG. 7, clamping tool 510 is shown according to an exemplary embodiment. Clamping tool 510 is substantially the same as clamping tool 10 and clamping tool 110 except for the differences discussed herein. Clamping tool 510 includes yet another shape of the grip section that may be applied to the crossover handle configuration disclosed herein. Here, upper and lower grip sections 516, 520 are shown respectively having a single dip 550 positioned near an opposite end of the respective grip section 516, 520 from the location at which the grip section 516, 520 connects to the respective crossover section 528, 534. Additionally, another variation of a versatile gripping zone 552 is shown, to support an even wider variety of gripping tasks. For example, versatile gripping zone 552 can support gripping tasks that require either fine teeth or coarse teeth. Versatile gripping zone 552 can also support gripping tasks the involve pulling small and/or large wires, as well as turning small and/or large nuts.

Referring to FIG. 8, an exploded view of the clamping tool 510 is shown. Here, the first handle 512 is shown separated from second handle 514. In this embodiment, the pivot joint is formed by a rivet 515 configured to rotatably couple the first handle 512 to the second handle 514 upon assembly. Additionally, a pair of grips 517 and 519, as described above, are shown separated from the rigid base of the respective first and second grip sections 516, 520.

Referring to FIG. 9, a side view of the clamping tool 510 is shown, with the clamping tool 510 arranged in an open position. Here, the grip portions 516, 520 are shown drawn sufficiently far away from one another as to uncross the crossover sections 528, 534 from one another, and to cause the neck sections 518, 522 to cross over one another and substantially uncross on opposite sides (compared to the closed position shown in FIGS. 7 and 10). When the distal ends of the grip sections 516, 520 are drawn apart a distance 554, jaws 530, 536 are separated at an angle C and by distance 556 at their respective distal ends. In the position shown in this embodiment, the distance 554 between the distal ends of the grip sections 516, 520 is approximately 8 inches, the distance 556 between the distal ends of the jaws 530, 536 is approximately 2 inches, and the separation angle C between the jaws 530, 536 is approximately 35 degrees. As shown in FIG. 9, the location at which crossover section 528 extends from neck section 518 is spaced apart from the location at which crossover section 534 extends from neck section 522 by a distance 555. In specific embodiments, distance 555 is equal to distance 556 between the distal ends of jaws 530, 536.

Referring to FIGS. 10-14, a series of rotated side views of the clamping tool 510 are shown, progressing from a closed position (FIG. 10) to open positions in which the jaws 530, 536 are separated at their distal ends by a separation distance 531. Various separation distances are shown in FIG. 11-14, as the upper and lower jaws 530, 536 are drawn open, specifically, separation distance 531 is shown as 0.5 inches (FIG. 11), 1 inch (FIG. 12), 1.5 inches (FIG. 13), and 2 inches (FIG. 14). As this progression occurs, the crossover sections 528, 534 uncross from one another, and the neck section 518, 522 cross over one another and then again substantially uncross.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention. In addition, as used herein, the article “a” is intended to include one or more component or element and is not intended to be construed as meaning only one.

Various embodiments of the invention relate to any combination of any of the features, and any such combination of features may be claimed in this or future applications. Any of the features, elements, or components of any of the exemplary embodiments discussed above may be utilized alone or in combination with any of the features, elements or components of any of the other embodiments discussed above.

What is claimed is:

1. A clamping tool comprising:
a lower jaw;
a first component comprising:
a first neck section extending from a first neck end to an opposing second neck end, the lower jaw at the first neck end;
a first cross over section extending upwardly from a first cross over end to an opposing second cross over end, the first neck section at the first cross over end; and
a first grip section extending from a first grip end to an opposing second grip end, the first cross over section at the first grip end;
an upper jaw, wherein the upper jaw is on an opposite side of a longitudinal axis of the clamping tool from the lower jaw;
a second component comprising;
a second neck section extending from a first neck end to an opposing second neck end, the upper jaw at the first neck end of the second component;
a second cross over section extending downwardly from a first cross over end to an opposing second cross over end, the second neck section at the first cross over end of the second component; and
a second grip section extending from a first grip end to an opposing second grip end, the second cross over section at the first grip end of the second component;
a pivot joint pivotably coupling the first component to the second component at the location at which the first neck section extends from the lower jaw and the second neck section extends from the upper jaw, the first component and the second component pivoting with respect to each other about a rotational axis as the upper jaw and the lower jaw are moved between an open configuration in which the upper jaw and the lower jaw are spaced apart and a closed configuration in which the upper jaw and the lower jaw contact each other;
a first distance along the longitudinal axis between the rotational axis and the second neck end of the first neck section when the upper jaw and the lower jaw are in the closed configuration; and
a second distance along the longitudinal axis between the second cross over end of the first grip section and a center point at which the first cross over section crosses over the second cross over section when the upper jaw and the lower jaw are in the closed configuration, wherein the second distance is less than 50% of the first distance.

2. The clamping tool of claim 1, wherein the second distance is less than 25% of the first distance.

3. The clamping tool of claim 1, comprising a third distance that is the entire length of the clamping tool along the longitudinal axis when the upper jaw and the lower jaw are in the closed configuration, wherein the first distance is at least 25% of the third distance.

4. The clamping tool of claim 3, comprising a fourth distance between the first grip end of the first grip section and the second grip end of the first grip section along the longitudinal axis when the upper jaw and the lower jaw are in the closed configuration, and a fifth distance between the first cross over end of the first grip section and the second cross over end of the first grip section along the longitudinal axis when the upper jaw and the lower jaw are in the closed configuration, wherein the first distance is at least 50% of the sum of the fourth distance plus the fifth distance.

5. The clamping tool of claim 1, comprising a fourth distance between the first grip end of the first grip section and the second grip end of the first grip section along the longitudinal axis when the upper jaw and the lower jaw are in the closed configuration, and a fifth distance between the first cross over end of the first grip section and the second cross over end of the first grip section along the longitudinal axis when the upper jaw and the lower jaw are in the closed configuration, wherein the first distance is at least 50% of the sum of the fourth distance plus the fifth distance.

6. The clamping tool of claim 1, comprising a fourth distance between the first grip end of the first grip section and the second grip end of the first grip section along the longitudinal axis when the upper jaw and the lower jaw are in the closed configuration, wherein the second distance is less than 25% of the fourth distance.

7. The clamping tool of claim 6, comprising a third distance that is the entire length of the clamping tool along the longitudinal axis when the upper jaw and the lower jaw are in the closed configuration, wherein the first distance is at least 25% of the third distance.

8. The clamping tool of claim 1, wherein, when the upper jaw and the lower jaw are in the closed configuration, the first neck section extends downwardly from the lower jaw at an angle of less than 10 degrees relative to the longitudinal axis.

9. The clamping tool of claim 8, wherein, when the upper jaw and the lower jaw are in the closed configuration, the first cross over section extends upwardly from the first neck section at an angle of less than 60 degrees relative to the longitudinal axis.

10. The clamping tool of claim 1, wherein, when the upper jaw and the lower jaw are in the closed configuration, the first cross over section extends upwardly from the first neck section at an angle of less than 60 degrees relative to the longitudinal axis.

11. The clamping tool of claim 1, wherein, when the upper jaw and the lower jaw are in the closed configuration, the first neck section extends downwardly from the lower jaw at a first angle relative to the longitudinal axis and the first cross over section extends upwardly from the first neck section at a second angle relative to the longitudinal axis, and wherein the first angle is less than the second angle.

12. The clamping tool of claim 11, wherein the first angle is less than half the second angle.

13. A clamping tool comprising:
a lower jaw;
a first component comprising:
a first neck section extending from a first neck end to an opposing second neck end, the lower jaw at the first neck end;
a first cross over section extending upwardly from a first cross over end to an opposing second cross over end, the first neck section at the first cross over end; and
a first grip section extending from a first grip end to an opposing second grip end, the first cross over section at the first grip end;
an upper jaw, wherein the upper jaw is on an opposite side of a longitudinal axis of the clamping tool from the lower jaw;
a second component comprising;
a second neck section extending from a first neck end to an opposing second neck end, the upper jaw at the first neck end of the second component;
a second cross over section extending downwardly from a first cross over end to an opposing second cross over end, the second neck section at the first cross over end of the second component; and
a second grip section extending from a first grip end to an opposing second grip end, the second cross over section at the first grip end of the second component;
a pivot joint pivotably coupling the first component to the second component at the location at which the first neck section extends from the lower jaw and the second neck section extends from the upper jaw, the first component and the second component pivoting with respect to each other about a rotational axis as the upper jaw and the lower jaw are moved between an open configuration in which the upper jaw and the lower jaw are spaced apart and a closed configuration in which the upper jaw and the lower jaw contact each other, wherein moving the grip section of the first component away from the grip section of the second component draws the upper jaw and the lower jaw apart from one another into an open configuration and moving the grip section of the first component towards the grip section of the second component draws the upper jaw and the lower jaw together into a closed configuration;
wherein, when the upper jaw and the lower jaw are in a closed configuration, the first cross over section of the first component crosses over the second cross over section of the second component, and the first cross over end of the first component is located below the first cross over end of the second component; and
wherein, as the upper jaw and the lower jaw are moved from the closed configuration to the open configuration, the first cross over section of the first component uncrosses from the second cross over section of the second component such that the first cross over end of the first component is positioned above the first cross over end of the second component.

14. The clamping tool of claim 13, wherein when the upper jaw and the lower jaw are in a closed configuration, the second cross over end of the first component is above the second neck end of the second component.

15. The clamping tool of claim 13, wherein when the upper jaw and the lower jaw are in a closed configuration, the second grip end of the first component is above the first grip end of the first component.

16. The clamping tool of claim 13, wherein when the upper jaw and the lower jaw are in a closed configuration, the first grip end of the first component is above the first grip end of the second component.

17. The clamping tool of claim 13, wherein, when the upper jaw and the lower jaw are in the closed configuration, the first neck section extends downwardly from the lower jaw at a first angle relative to the longitudinal axis and the first cross over section extends upwardly from the first neck section at a second angle relative to the longitudinal axis, wherein the first angle is less than half the second angle.

18. A clamping tool comprising:
a lower jaw;
a first component comprising:
a first neck section extending from a first neck end to an opposing second neck end, the lower jaw at the first neck end;
a first cross over section extending upwardly from a first cross over end to an opposing second cross over end, the first neck section at the first cross over end; and
a first grip section extending from a first grip end to an opposing second grip end, the first cross over section at the first grip end;
an upper jaw, wherein the upper jaw is on an opposite side of a longitudinal axis of the clamping tool from the lower jaw;
a second component comprising;
a second neck section extending from a first neck end to an opposing second neck end, the upper jaw at the first neck end of the second component;
a second cross over section extending downwardly from a first cross over end to an opposing second cross over end, the second neck section at the first cross over end of the second component; and
a second grip section extending from a first grip end to an opposing second grip end, the second cross over section at the first grip end of the second component;
a pivot joint pivotably coupling the first component to the second component at the location at which the first neck section extends from the lower jaw and the second neck section extends from the upper jaw, the first component and the second component pivoting with respect to each other about a rotational axis as the upper jaw and the lower jaw are moved between an open configuration in which the upper jaw and the lower jaw are spaced apart and a closed configuration in which the upper jaw and the lower jaw contact each other, wherein moving the grip section of the first component away from the grip section of the second component draws the upper jaw and the lower jaw apart from one another into an open configuration and moving the grip section of the first component towards the grip section of the second component draws the upper jaw and the lower jaw together into a closed configuration;
wherein, when the upper jaw and the lower jaw are in the closed configuration, the first neck section extends downwardly from the lower jaw at an angle of less than 45 degrees relative to the longitudinal axis and the second neck section extends upwardly from the upper jaw at an angle of less than 45 degrees with respect to the longitudinal axis; and
wherein as the upper jaw and the lower jaw are moved into the open configuration, the first neck section is drawn upward until the first neck section extends upwardly from the lower jaw and the second neck section is drawn downward until the second neck section extends downwardly from the upper jaw.

19. The clamping tool of claim 18, wherein, when the upper jaw and the lower jaw are in the closed configuration, the first cross over section extends upwardly from the first neck section at an angle between 35 degrees and 55 degrees relative to the longitudinal axis.

20. The clamping tool of claim 18, wherein, when the upper jaw and the lower jaw are in a closed configuration, the second neck end of the first component is below the second neck end of the second component and the first grip end of the first component is above the first grip end of the second component.
